(19) United States
(12) Patent Application Publication
(10) Pub. No.: US 2022/0305838 A1
(43) Pub. Date: Sep. 29, 2022

(54) Gamebook with a spinner mechanic

(71) Applicants: Francesca Anne Moyse, Cohasset, MA (US); Isaiah Murray, Cohasset, MA (US); Gabriel Murray, Cohasset, MA (US)

(72) Inventors: Francesca Anne Moyse, Cohasset, MA (US); Isaiah Murray, Cohasset, MA (US); Gabriel Murray, Cohasset, MA (US)

(21) Appl. No.: 17/300,146

(22) Filed: Mar. 27, 2021

(51) Int. Cl. B42F 21/02; A63F 9/04; F21V 33/00

(52) U.S. Cl. CPC B42F 21/02; A63F 9/04; F21V 33/0004; F21Y 2115/10

(57) ABSTRACT

A gamebook with a spinner mechanic is provided that allows a player to enact an interactive activity such as but not limited to dungeon exploration, art creation, board game, or maze. The gamebook provides the spinner mechanic under the activity sheets, with cutout sections enabling players to see and interact with the spinner on every sheet of the gamebook. Tabbed sheets may provide player instructions for activities, enabling complex activities and algorithms to be enacted in a gamebook medium. The gamebook may have pullout sections to track activity progress such as a pullout page that unfolds with progress trackers such as paperclips attached for further player interaction. This gamebook with a spinner mechanic may also be provided in a digital medium to enact the same interactive activity experience for players who do not have access to a physical gamebook.

### BACKGROUND

The disclosed subject matter is directed generally to published and digital materials with the purpose of guiding a player or players through a number of gamebook and or activity book activities.

Gamebooks and activity books have presented a familiar set of experiences such as sudoku, word play, crosswords, mazes, coloring books, or other such fun activity, for many years now. A person may grab a pencil and a gamebook and have an entertaining experience. However, it is hard for a player of such a gamebook to have a more interactive experience such as that provided by a board game or video game with a gamebook without adding dice, cards, or other external mechanics to the gamebook to enable random experiences and ever changing game play.

Some gamebooks do enable and provide for more interactive experiences by encapsulating complex rules in their pages, and requiring a player to provide their own additional objects, such as note paper, grid paper, various dice, playing pieces, to fully experience the game. Role playing game rule books are one such example of this approach to more interactive gamebooks. However, such gamebooks do not provide a fully contained experience in the book itself.

Video games have commonly provided such interactive experiences to players—such as “rogue-like” games wherein a player traverses a dungeon or other such game world, and randomly generated numbers determine the type of encounters, items, monsters, and other such elements of the game. Players can then experience an infinite number of fun experiences from a single such game algorithm. However, gamebooks have not been able to provide such an experience to players.

### BRIEF SUMMARY

According to an implementation of the disclosed subject matter, a gamebook may be created that enables a player to experience a randomly generated game. The gamebook may consist of a binding enclosure containing, in order, a series of pages containing game maps and game instructions, a spinner mechanism, and a pullout page that unfolds to extend beyond the border of the binding enclosure when unfolded. The gamebook may further have a binding mechanism that enables adding and removing game maps and instructions to play different types of games (or art activities, and so on).

If we are looking at an open gamebook, the spinner mechanism and game instruction pages may be positioned on the right hand side of the book taking up the upper third of the book layout, with the game maps on the right hand side taking up the bottom two thirds such that both are visible at the same time. The pullout page may then unfold to extend beyond the binding enclosure to the right or left.

The spinner mechanism may present a spinner with an arrow or other such indicator that can be spun by the player to randomly select an outcome. The outcomes may be printed on various game instruction pages, or may be provided in markings underneath the spinner area. The spinner mechanism may be constructed of wood, plastic, thick paper, cardboard, or other rigid material and may provide additional rigidity to better enable drawing on the gamebook. The spinner mechanism may further contain raised elements that may be used to provide support to the game instruction and map pages.

The game instructions pages may be separated from the game map pages such that the player may switch (paginate) between different instruction pages while remaining on the same game map page. Some of the game instruction pages may have cutouts to enable them to be overlaid on the spinner mechanism, such that a player may spin the spinner and have it point to one of the instructions on the instruction page.

The pullout page may include moveable indicators to track a player's game statistics such as health. Such indicators may be implemented using paperclips, magnets, or using more complex paper mechanisms such as pull-out tabs or spinning wheels.

The game map pages may be printed with grids or other game activity templates that enable game play in coordination with the instruction pages.

A player playing this gamebook would do so as follows. First, they open the book, unfolding the pullout page to display their game metrics (health and equipped items). They then read the game overview and instructions on the first few full sized pages, then arrive at the first page with game maps and game instructions. Finally they begin to spin the spinner to determine what map tile to draw in the next open position, after which they draw that map tile in themselves using a pen, pencil, or other such writing device. They continue spinning the spinner to discover what to draw on the map, and have their character navigate the map as possible based upon obstructions and other game play elements.

A gamebook may contain many single page games, or it may contain complex games spanning multiple pages of maps and instructions. A simple game might be a game where players spin to discover the next map tile to place, with the goal to construct a path from one location on the map to another. A more complex game might be a game where players explore a world of grasslands, swamps, deserts, mountains, forests, and caves, with maps linking to one another via “magic portals” and “caves”, and the game instructions detailing the method of creating the map varying depending on complex rules across multiple instruction pages. More complex games may include elements of discovering and or equipping items, encountering and or fighting monsters and other characters, and leveling up as players successfully navigate the game. In this way, a complex game may be equivalent to a paper based video game.

A gamebook as described here may also be created and presented to players digitally, such that a web or mobile application is created to replicate the experience of playing the physical gamebook. This digital gamebook may include the spinner mechanism with the game instructions overlaid around the spinner, and the game map underneath. Digital pagination and other methods of switching between instructions and map pages may be provided to players. As a digital device may not provide the ability to unfold a page beyond the device (as the pullout page does in the physical book), the digital version of the gamebook may present these in modal dialogs or other graphical user experience methods as appropriate to play the gamebook on a limited device screen.

Additional features, advantages, and implementations of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a closed gamebook according to an implementation of the disclosed subject matter.

FIG. 2A shows an open gamebook according to an implementation of the disclosed subject matter. FIG. 2B shows an open gamebook with pages turning according to an implementation of the disclosed subject matter.

FIG. 3 shows a pullout page folded and unfolded according to an implementation of the disclosed subject matter.

FIG. 4 shows a gamebook title page according to an implementation of the disclosed subject matter.

FIG. 5 shows a gamebook's overview and instruction pages according to an implementation of the disclosed subject matter.

FIG. 6 shows a gamebook spinner instructions and map pages according to an implementation of the disclosed subject matter.

FIG. 7 shows a gamebook spinner mechanism page according to an implementation of the disclosed subject matter.

FIG. 8 shows a gamebook spinner mechanism according to an implementation of the disclosed subject matter.

FIG. 9 shows a gamebook spinner instruction pages closeup according to an implementation of the disclosed subject matter.

### DETAILED DESCRIPTION

A gamebook with a spinner mechanic is provided herein. The gamebook may enable a player to enact a number of different games incorporating an element of chance via the included spinner mechanic. The element of chance may be applied to the gamebook activity via instruction pages that are placed over the spinner mechanic, or other instructions included elsewhere in the gamebook. The player may track their progress in a game or activity using map pages or pullout pages in the gamebook.

According to an implementation disclosed herein, a gamebook may contain zero or more single page activities, or it may contain zero or more complex activities spanning multiple pages of maps and instructions. A simple activity might be a game where players spin to discover the next map tile to place, with the goal to construct a path from one location on the map to another. A more complex activity might be a game where players explore a world of grasslands, swamps, deserts, mountains, forests, and caves, with maps linking to one another via “magic portals” and “caves”, and the game instructions detailing the method of creating the map varying depending on complex rules across multiple instruction pages. More complex games may include elements of discovering and or equipping items, encountering and or fighting monsters and other characters, and leveling up as players successfully navigate the game. In this way, a complex game may be equivalent to a paper based video game. Activities need not only be games, as artistic applications such as drawing or coloring by number activities may be implemented.

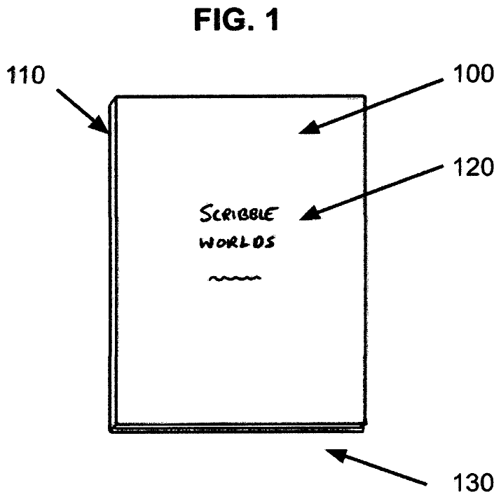

Implementations of the presently disclosed subject matter may be implemented in and used with a variety of gamebook layouts, arrangements, binding mechanisms, and other variations in publication and printing format. FIG. 1 is an example gamebook 100 suitable for implementations of the presently disclosed subject matter. The gamebook 100 includes a binding mechanism 110 and may include a book cover or other such contents disclosing its title and presenting marketing materials 120 on the front, back and spine of the gamebook. The gamebook itself may Contain multiple pages 130 inside the binding enclosure.

Many other elements of a published gamebook (not shown) may be included in the gamebook in a similar manner (e.g., sudoku sheets, blank drawing pages, coloring pages and so on). Conversely, all of the elements shown in these FIGS. 1 through 9 need not be present to practice the present disclosure. The gamebook may be constructed in different ways from that shown.

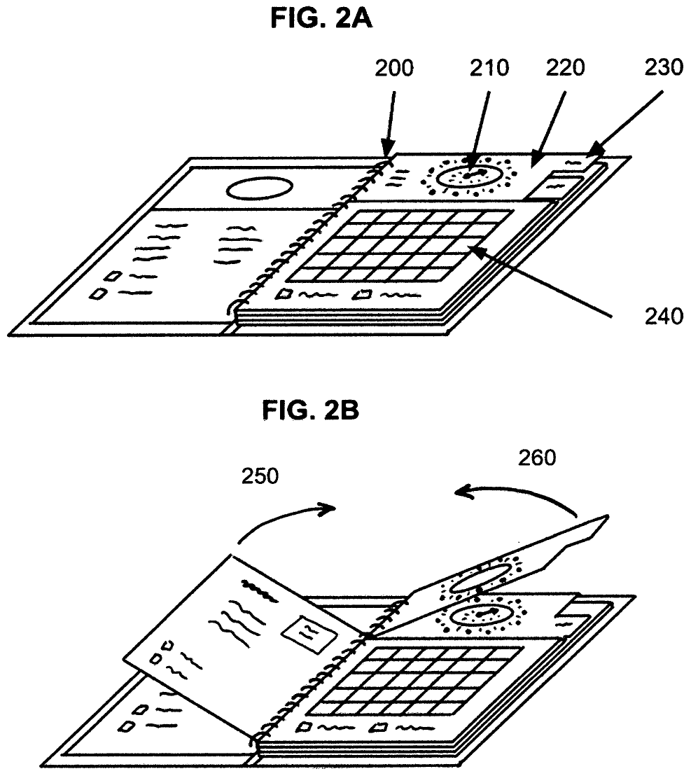

FIG. 2A shows an example of an open gamebook opened to a game play page. This shows a binding mechanism 200 which may be opened to enable changing out the game instructions, map pages, pullout pages, and other contents of the gamebook. The spinner mechanic 210 is also shown, with the game instruction pages 220 surrounding it, with a cutout to enable the spinner to be seen by the player regardless of which game instruction page 220 or map page 240 they are currently turned to. Game instruction pages may include tabs 230 to help players select the correct game instruction page based upon the game rules and spinner results.

FIG. 2B shows an example of an open gamebook with a map page 250 and an instruction page 260 being turned to illustrate that these pages are separated from each other and may be paginated individual, and to further illustrate the cutout that enables the instruction page 260 to be overlaid on the spinner mechanic 210.

More generally, various layouts and arrangements of the instruction pages, map pages, and spinner mechanic may be implemented other than that shown here. Implementations may also be implemented in the form of digital representations of the gamebook, gamebook contents, and spinner mechanic.

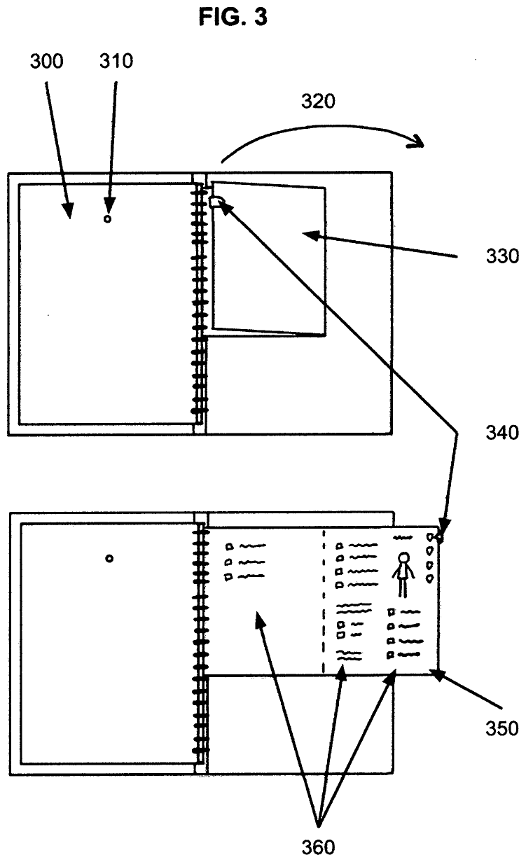

As shown in FIG. 3, the gamebook may include a pullout page 350 which is here shown on the last page of the gamebook in this implementation, behind the spinner mechanic page 300 which also shows the back side of the fastener 310 used to connect the spinner mechanic to the spinner mechanic page.

The pullout page 350 may be folded when stored, and then unfolded as shown by motion arrow 320 to extend beyond the binding enclosure to the right or left (shown here extending on the right) 350. The pullout page may include printed templates 360 to be filled in and or otherwise modified by the player, as well as moveable indicators 340 to track a player's game statistics (shown here as health hearts).

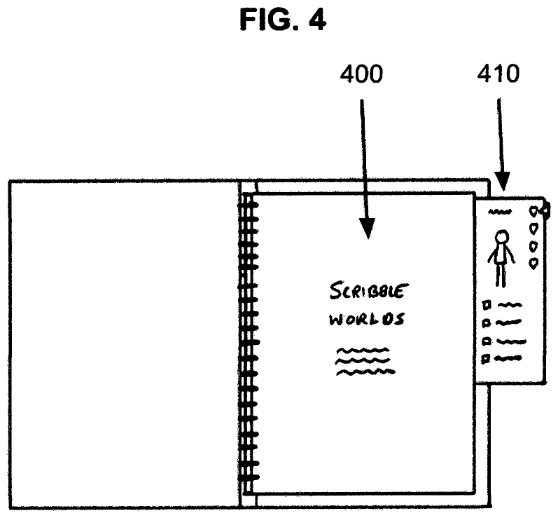

FIG. 4 shows the unfolded pullout page 410 extending beyond the binding enclosure on the right of the title page 400 of the gamebook.

Many other elements of a pullout page (not shown) may be included in a gamebook, as may multiple pullout pages (or no pullout pages). The concept of a pullout page may extend beyond tracking a character's progress in the gamebook to include other tracking indicators or other gamebook activity supporting contents. Moveable indicators 340 are shown here as simple paperclip style markers, but may be implemented in many other ways such as using magnets or more complex paper mechanisms such as pull-out tabs or spinning wheels. All the elements in FIG. 3 and FIG. 4 need not be present to practice the present disclosure.

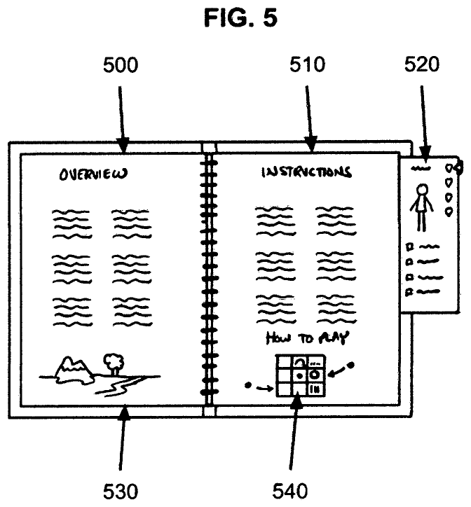

As shown in FIG. 5, the gamebook may include one or more overview pages 500 introducing the gamebook concept and contents, including attractive graphics 530, as well as player instructions 510 informing players how to use the gamebook. Instructions may include detailed graphics 540 illustrating how to use the spinner mechanic to enact gamebook activities. The pullout page 520 may remain present regardless of which page the player is turned to.

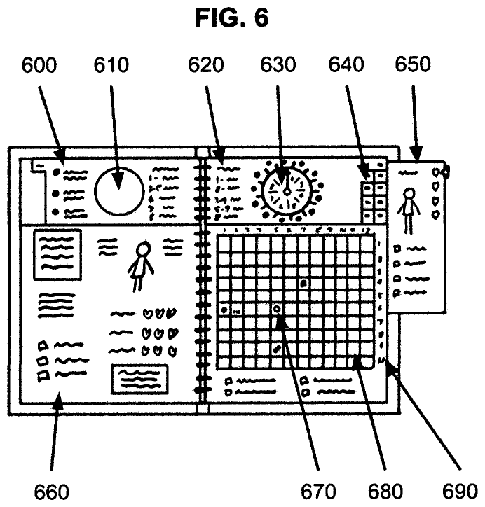

FIG. 6 shows the gamebook open to a set of game instruction pages 260 and map pages 250 with further examples of possible contents for such pages called out in detail. Game instructions may be presented in multiple places, including on the back of instruction pages 600, on the face of instruction pages 620, and around the spinner mechanic itself 630. The spinner mechanic 630 remains available for player interaction regardless of which instruction page is selected thanks to the cutout 610 in each instruction page. Instruction pages may be assembled with tabs 640 to help players switch between instruction pages. The pullout page 650 may remain visible while the player is playing the gamebook. Gamebook activity instructions, progress tracking, entertainment contents, and other information may be placed on the front or back of the game map pages as shown in 660. The map pages 250 may include grids 680 to help players enact the gamebook activity. These grids may have row and column indicators 690 to help players identify the position of a player or other game element while playing a gamebook activity. The grids on map pages may start blank or be prefilled with game contents 670.

FIG. 6 also shows how the player instructions 510 and instruction pages 260 may coordinate with the map pages 250 to enable game play in coordination with the instruction pages. The player may start playing at the location on the map page 250 as indicated by prefilled game contents 670, then may follow instructions from player instructions 510 and instruction pages 260 to spin the spinner to determine the next action in their gamebook activity. The player may then complete the action as instructed, modifying the map page 250, pullout page 650, or other contents 660 to track their progress.

Again, all of the elements shown need not be present, nor need they be present in the arrangement shown in these figures. The spinner cutouts need not be circular, the tabs may be positioned elsewhere, or other pagination support elements may be implemented. The grid is not required for a gamebook map page, nor must the grid be rectangular— other grids may be used as well, whether hexagonal, dot grid, or other.

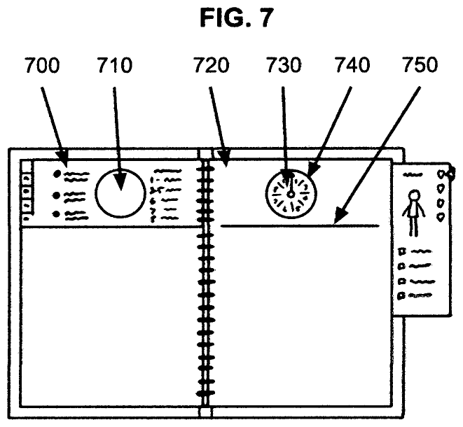

FIG. 7 shows the front of an example spinner mechanic page 720 as well as the back of an instruction page 260 with instructions 700 and spinner cutout 710. The front of the spinner mechanic page 720 may include the spinner mechanic 730, printed, etched, or otherwise present spinner graphics and results contents 740, and raised elements 750 that may be used to provide support to the game instruction and map pages. When an instruction page 260 is placed over the spinner mechanic 730, these raised elements 750 may provide a shelf or otherwise hold them in place such that the instruction page 260 remains in place (vs. drooping or wiggling around as it might otherwise do if the binding mechanism has an imperfect tolerance).

The spinner mechanic page 720 may be constructed of numerous materials from paper to plastic to cardboard to wood to metal and so on. Likewise the spinner mechanic 730 may be constructed of numerous materials. The spinner mechanic page 720 need not contain all of the elements to practice the present disclosure, and may contain many other elements as well.

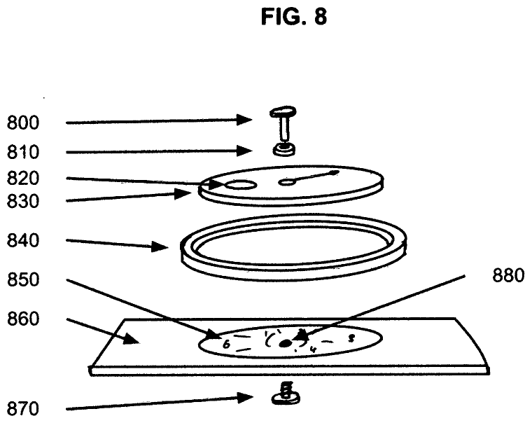

FIG. 8 illustrates one example of a spinner mechanic 730 construction. The spinner mechanic 730 may be constructed with a fastener 800, a bearing 810, a spinner wheel 830 (including one or more finger holes 820 to enable easier spinning), a raised element 840 in the shape of the instruction page 260 spinner cutout, a spinner graphics and results contents 850, a spinner mechanic page 860, a hole 880, and another fastener 870 to bind all of these elements together. The raised element 840 may be glued or otherwise attached to the spinner mechanic page 860 such that it does not obstruct the spinner wheel 830 as it spins on the fastener 800 and bearing 810.

The spinner wheel 830 may be constructed of transparent material to enable the player to see the spinner graphics and results contents 850, conversely the spinner graphics and results contents may be printed on the spinner wheel 830 itself, with an indicator on the instruction pages 260 or the raised element 840 to indicate which of the spinner graphics and results contents are to be selected for any given spin.

Many other types of a spinner (not shown) may be included in the spinner mechanic in a similar manner (e.g., arrows, other types of wheels, other shapes). Conversely, all of the elements of spinner mechanic construction need not be present to practice the present disclosure. The spinner mechanic may be constructed in different ways from that shown.

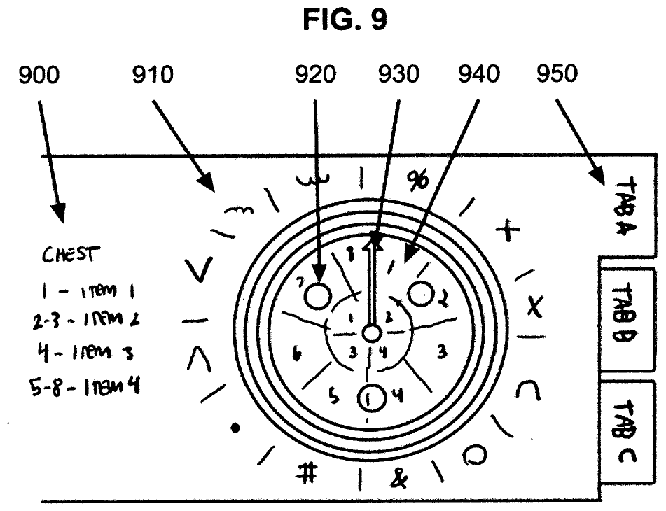

FIG. 9 shows a top down view of the spinner mechanic 730 with an instruction page 260 overlaid on top of and around it. This shows some further examples of how the spinner mechanic 730 may be used to enact a gamebook activity wherein the player randomly selects an outcome. The player spins the spinner wheel 830, possibly using a finger hole 920 to do so. The spinner wheel 830 spins until it stops, at which point an indicator 930 indicates which result has been randomly selected. Here the indicator 930 is indicating that the player has landed on a spinner outcome 910, in this case selecting the ‘%’ outcome which is printed on this instruction page 260. In other cases, the instructions may tell the user to spin a particular random number (D4, D6, D8, D10, D12, D20, and so on) which are printed on the spinner graphics and results contents 850. In this case the indicator 930 is indicating the number ‘8’ is the spinner outcome, which can be used in various lookup tables 900 or other such player instructions to determine the next action or outcome of the gamebook activity. At certain times, such activities may include changing from one instruction page 260 to another, which may be accomplished using the instruction page tabs 950.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed Subject matter and their practical applications, to thereby enable others skilled in the art to utilize those implementations as well as various implementations with various modifications as may be suited to the particular use contemplated.

The invention claimed is:

1. A gamebook with spinner mechanic comprising:
a) One or more pages directing a user through one or more gamebook activities; and
b) One or more spinner mechanics to introduce an element of chance into the gamebook activities; and
c) One or more pages that direct a user through one or more gamebook activities incorporating the spinner mechanic.

2. The gamebook of claim 1, designed to support the addition and removal of gamebook activities.

3. The gamebook of claim 1, designed to have zero or more separated instruction and gamebook activity pages in one binding apparatus able to be paginated individually.

4. The gamebook of claim 1, designed to have zero or more pages with cutouts to enable the spinner mechanic to be visible as the player switches between pages.

5. The gamebook of claim 1, designed to have zero or more pages with tabs to enable the player to switch between pages.

6. The gamebook of claim 1, designed to have zero or more pullout pages with zero or more moveable indicators as part of a gamebook activity.

7. The gamebook of claim 1, designed to be published digitally on a smartphone, tablet, or other computing device.

8. A gamebook spinner mechanic comprising:
a) A spinner mechanism such as an arrow or wheel; and
b) A mechanism to connect the spinner to the gamebook.

9. The gamebook spinner mechanic of claim 8, designed to have player instructions printed or otherwise made visible on the spinner, or the mechanism that connects the spinner to the gamebook.

10. The gamebook spinner mechanic of claim 8, designed to have raised elements that provide support to the gamebook pages.

11. The gamebook spinner mechanic of claim 8, designed to provide a rigid backplane to the gamebook pages.

12. The gamebook spinner mechanic of claim 8, designed to have a more statistically random spinner through use of a spinning wheel (as opposed to a spinning arrow or other mechanism).

13. The gamebook spinner mechanic of claim 8, designed to be more easily spun by a player through the addition of finger holes or other affordances.

14. The gamebook spinner mechanic of claim 8, designed to provide an alternative to typical playing dice through the addition of ordered printed numbering for zero or more D2, D4, D6, D8, D10, D12, D20, D100 dice.

15. The gamebook spinner mechanic of claim 8, designed to be separable from the gamebook.

16. The gamebook spinner mechanic of claim 8, implemented via a digital or other electronic mechanism such as a small LED and battery that displays a spinner or other element of chance such as dice or random numbers.

17. The gamebook spinner mechanic of claim 8, designed to be implemented digitally on a smartphone, tablet, or other computing device.
